(19) United States
(12) Patent Application Publication
(10) Pub. No.: US 2011/0119197 A1
(43) Pub. Date: May 19, 2011

(54) LEGAL COMMUNICATIONS MANAGEMENT MOBILE APPLICATION

(76) Inventor: JASON TURCHIN, WESTON, FL (US)

(21) Appl. No.: 12/620,900

(22) Filed: Nov. 18, 2009

(51) Int. Cl. G06Q 50/00; G06F 15/16; G06F 3/01

(52) U.S. Cl. 705/311; 709/206; 715/781

(57) ABSTRACT

An automated system for providing legal matter updates can include a legal matter management application and a legal matter update service application. The legal matter management application can run on a mobile device and can be configured to organize legal matter data pertaining to legal proceedings. The legal matter update service application can be configured to identify and convey legal matter update messages about the legal proceedings from a legal business computing system to the legal matter management application. The legal matter update message can include one or more elements of legal matter data.

A method for potential clients and existing clients to communicate directly with a specific legal counsel can include a legal matter management application. The legal matter management application can be configured to provide specific information pertaining to that legal counsel, such as prior verdicts/settlements, legal advice, background information, and a contact element. Once a client or potential client avails themselves to the legal matter management application, the client or potential client permits direct communication with specific legal counsel and is not considered solicitation.

### BACKGROUND

The present invention relates to the field of client-attorney communication and, more particularly, to a method for client-attorney communication through a legal communications management mobile application.

Clients are often frustrated by an inability to easily communicate with their attorney and by their lack of legal knowledge and information regarding the type of case for which they seek legal representation. Legal counsels often perform a great deal of work that clients are not aware of on a particular legal matter. From the attorney perspective, the client-attorney communication often requires significant administrative overhead on the part of the legal counsel and/or his staff. Coordinating meetings, collating documents, and disseminating information takes considerable time and resources. This often leaves clients feeling ignored or neglected, darkening their legal experience.

A significant complication to client-attorney communications relates to State Bar rules established to minimize direct solicitation with potential clients. That is, most state bars impose restrictions on direct attorney-to-client communications until a relationship has been established. Further, state bar advertising rules minimize what attorneys are permitted to say when advertising their services to the public. Clients, conversely, are often reluctant to initiate communications with attorneys who are unfamiliar to them. Thus, both clients and legal counsels would benefit from a communication forum that would disseminate law firm information in a less hampered fashion, provided that a client or potential client gives explicit permission as required by state bar advertising rules. Such a forum would not be an open communication forum (which would be subject to anti-solicitation restrictions).

The transition of many legal counsels/firms to electronic document systems and/or related case management software systems has not greatly improved client-attorney communication. The purpose of the technology is for legal counsel to more efficiently manage a client's matter within the law firm or law office, but this does not further the client-attorney communication relationship. The technology serves the legal counsel but not necessarily the client or potential client. For example, electronic files containing legal documents require that the client have a computing device with the appropriate viewing application and/or application version. Additionally, the client must have adequate bandwidth for file transfers.

Email, social networking applications, and instant messaging are great tools for quick client-attorney communication. However, these tools require clients and/or potential clients to take time to go to each individual communication medium to communicate with their specific legal counsel, and may also require membership on the part of the legal counsel and the client, as well as additional time from the legal counsel or his staff.

Updating existing clients on case status also requires significant time and expense from legal counsel and/or his staff. That is, notifying a client about the availability of a document or the occurrence of an event would require the legal counsel or staff member to halt a current activity and then generate and send the notification to the client via electronic mail, verbally through a telephone call, and/or through a postal service (i.e. USPS or Federal Express). While this is common practice, a large quantity of clients and/or notifications quickly adds up to a considerable amount of time and money.

### BRIEF SUMMARY

One aspect of the present invention can include an automated system for providing legal matter updates. Such a system can include a legal matter management application and a legal matter update service application. The legal matter management application can run on a mobile device and can be configured to organize legal matter data pertaining to legal proceedings. The legal matter update service application can be configured to identify and convey legal matter update messages about the legal proceedings from a legal business computing system to the legal matter management application. The legal matter update message can include one or more elements of legal matter data.

Another aspect of the present invention can include an automated method for providing legal matter updates. Such a method can begin with the detection of a predefined event within a legal business computing system by a legal matter update service. The predefined event can require an electronic communication to one or more designated legal clients. A legal matter update message can then be automatically generated for the predefined event. The legal matter update message can be conveyed to the legal matter management application running on a mobile device of each designated legal client.

Yet another aspect of the present invention can include a computer program product that includes a computer readable storage medium having embedded computer usable program code. The computer usable program code configured to detect a predefined event within a legal business computing system. The predefined event can require an electronic communication to one or more designated legal clients. The computer usable program code can be configured to automatically generate a legal matter update message for the predefined event. Lastly, the computer usable program code can be configured to convey the legal matter update message to a legal matter management application running on a mobile device of each designated legal client.

### BRIEF DESCRIPTION OF THE SEVERAL VIEWS OF THE DRAWINGS

FIG. 1 is a schematic diagram illustrating a system that automatically communicates legal matter update messages to clients of legal counsel in accordance with embodiments of the inventive arrangements disclosed herein.

FIG. 2 is a component diagram of a legal matter management application in accordance with an embodiment of the inventive arrangements disclosed herein.

FIG. 3 is a collection of mobile device graphical user interfaces (GUIs) illustrating a sample implementation of the legal matter management application in accordance with an embodiment of the inventive arrangements disclosed herein.

FIG. 3A is a collection of basic legal advice GUIs.

FIG. 3B is a collection of My Legal Matters GUIs.

### DETAILED DESCRIPTION

The present invention discloses a solution that can automatically communicate update information regarding legal proceedings to clients of legal counsel. A legal matter update service application can detect update events within the legal business computing system of the legal counsel. For each update event, the legal matter update service application can generate a legal matter update message and convey the legal matter update message to a legal matter management application running on a mobile device of the associated client. The service application to mobile device communication channel can be a secure one, such as one employing public/private key encryption techniques. In one embodiment, the law firm can advertise new legal services to the mobile device users via the legal mobile application. In one contemplated embodiment, a set of different law firms and/or legal practitioners can utilize a common mobile device application, which is able to interactively provide clients and potential clients with firm-specific material.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

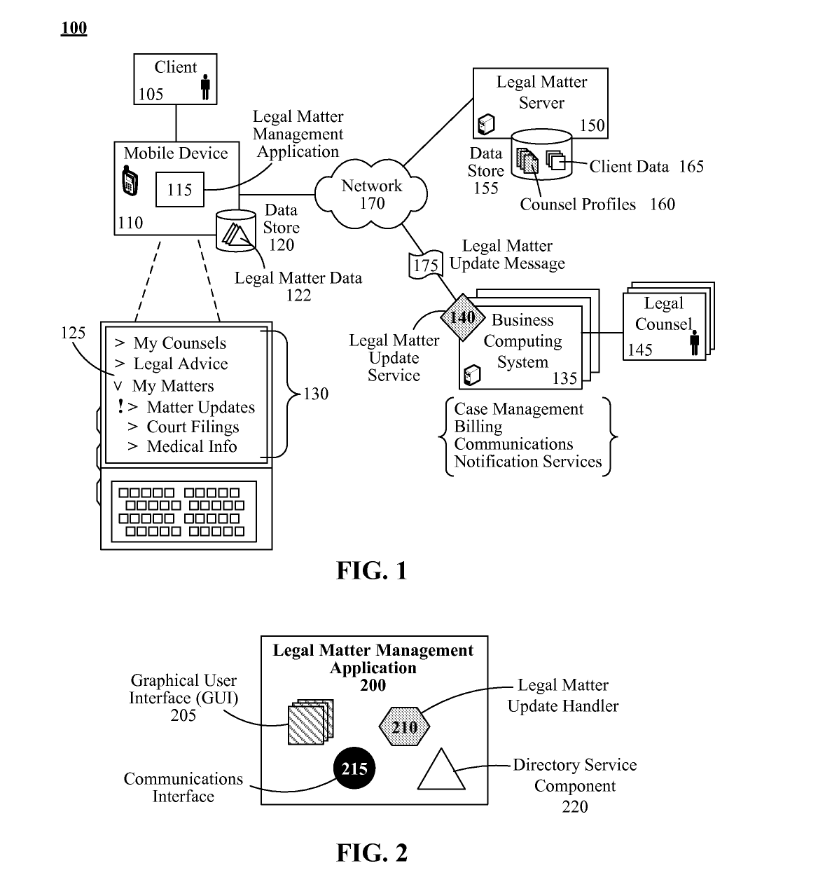

FIG. 1 is a schematic diagram illustrating a system 100 that automatically communicates legal matter update messages 175 to clients 105 of legal counsel 145 in accordance with embodiments of the inventive arrangements disclosed herein. In system 100, a client 105 can utilize a legal matter management application 115 running on a mobile device 110 to view and/or perform response actions to legal matter update messages 175 received over a network 170 from a legal matter update service 140 monitoring events within the business computing system 135 of a legal counsel 145.

As used herein, the terms “client” and “legal counsel” are used to refer to both individual and corporate entities. That is, a client 105 can represent an individual person or entire organization, and a legal counsel 145 can represent a single practicing attorney, law team, or law firm.

The business computing system 135 can represent the hardware and/or software components utilized by the legal counsel 145 to conduct business activities. The legal matter update service 140 can represent a software application capable of interacting with the business computing system 135 of the legal counsel 145 to generate and convey legal matter update messages 175 to the legal matter management application 115 of the client 105. As shown in system 100, the legal matter update service 140 can run as a component of the business computing system 135.

The legal matter update service 140 can be configured to monitor the business computing system 135 for the occurrence of specific events for which the legal counsel 145 desires to have legal matter update messages 175 automatically sent to the client 105. Examples of such events can include, but are not limited to, a change of a case status within a case management software system, a newer version of an electronic document within a document management system, a new electronic document added to a document management system, a change to meeting data within a scheduling software application, and the like. Data regarding the configuration of the legal matter update service 140 by the legal counsel 145 can be stored within the business computing system 135.

It should be noted that the specific events for which the legal matter update service 140 monitors the business computing system 135 is dependent upon the composition of the business computing system 135 as well as the wishes of the legal counsel 145. In one contemplated embodiment, potential updates to be sent to mobile devices 110 can require approval by legal counsel 145 or legal counsel staff before being conveyed. In another embodiment, the business computing system 135 and/or server 150 can establish a set of counsel 145 confirmable rules for disseminating messages 175 to mobile devices 110.

In one embodiment, the legal matter update service 140 can operate external to the business computing system 135, such as on legal matter server 150. As such, the legal matter update service 140 can be configured to periodically poll the business computing system 135 over the network 170 to detect events requiring generation of legal matter update messages 175. Additionally, event configuration made by the legal counsel 145 can be stored within the data store 155 in a corresponding counsel profile 160.

When an event occurs, the legal matter update service 140 can query the business computing system 135 for information necessary to generate the legal matter update message 175, which can represent a textual note describing the event occurrence. For example, the detection of a change to the case status within the case management system can require the legal matter update service 140 to determine the clients 105 associated with the case. The legal matter update service 140 can then correlate the client 105 identification from the business computing system 135 with a set of client data 165 to determine where to send the legal matter update message 175.

The legal matter update service 140 can be provided to a set of different law firms for a fee. In one embodiment, the legal matter update service 140 can enable new law firms to communicate to new clients 105. These new clients 105 can include mobile device 110 owners who have installed the legal matter management application 115. Installation of the legal matter management application 115 can include agreed upon conditions, such as a condition that client 105 welcomes information from legal counsels 145 participating in the legal matter update service 140. In one embodiment, restrictions can be optionally imposed, where clients 105 can constrain what type of information they would like to receive from a legal counsel 145.

The client data 165 can represent information collected about the client 105 that can affect operation of the legal matter update service 140 and/or the legal matter management application 115. For example, the client data 165 can include items such as a unique identifier of the mobile device 110, an email address, and an instant messaging (IM) identifier.

The client data 165 can be stored in the data store 155 of a legal matter server 150. The legal matter server 150 can represent the hardware and/or software required to support operation of the legal matter management application 115 and legal matter update service 140. For example, legal matter update messages 175 can be stored in the data store 155 for future delivery when the mobile device 110 is not accessible over the network 170.

In another embodiment, the legal matter server 150 can operate from within the business computing system 135. In such an embodiment, the functionality of the legal matter server 150 can be limited to the associated legal counsel 145.

In an alternate embodiment, the role of the legal matter server 150 can be expanded to include a directory service (not shown). The directory service can provide the legal matter management application 115 with the ability to search the counsel profiles 160. A counsel profile 160 can include information about a legal counsel 145 such as office location, office hours, and area of expertise. The creation of a counsel profile 160 can be a requirement for utilizing the directory service 155.

In yet another contemplated embodiment, the directory service can be provided by a third-party computing system (not shown) capable of communicating with the legal matter management application 115 over the network 170. As such, a legal counsel 145 would be required to register with the third-party directory service in order to have their information distributed to the legal matter management application 115.

Once generated, the legal matter update message 175 can be conveyed over the network to the legal matter management application 115 running on a mobile device 110 of the client 105. The mobile device 110 can represent a variety of portable computing devices having a data store 120 and capable of running the legal matter management application 115 and communicating with other entities over a network 170. Examples of the mobile device 110 can include, but are not limited to, a personal data assistant (PDA), a smart phone, a network-capable cell phone, a laptop computer, a portable multimedia player, and the like. Different client-side applications 115 can exist for different mobile device 110 platforms.

As shown in system 100, an example illustration of the mobile device 110 can include a display area 125 in which to present the graphical user interface (GUI) 130 of the legal matter management application 115. Interactive elements of the GUI 130 can be selected by the client 105 utilizing the input mechanisms supported by the mobile device 110, such as a touch screen or keyboard.

The legal matter management application 115 can represent a software application designed to operate on the mobile device 110 (e.g., an iPHONE application) and can be configured to present the legal matter data 122 of the client 105 in an organized manner. The legal matter data 122 can be extracted from received legal matter update messages 175 and can be stored within a data store 120 of the mobile device 110. Additionally, the legal matter data 122 can also include data supporting additional features of the legal matter management application 115 such as legal advice information.

While the previous examples have focused on the scenario where the client 105 has an existing relationship with the legal counsel 145, it is important to note that the legal matter management application 115 can also be of value to potential clients 105. In one embodiment, the legal matter management application 115 can be branded for a specific legal counsel 145 to whom a potential client 105 wishes to contact. The legal matter management application 115 can then provide the potential client 105 with all available contact information for that legal counsel 145 in a compact and efficient format. Alternately, a potential client 105 can use the directory service, when available, to research a potential legal counsel 145.

It should be noted that the communication of legal matter update messages 175 can occur in one direction. That is, the legal matter update service 140 can be configured to only send legal matter update messages 175, not receive, while the legal matter management application 115 can receive legal matter update messages 175, not send. Any return communications by the client 105 to the legal counsel 145 can be made utilizing existing digital communication media supported by the mobile device 110.

For example, a client 105 can respond to a received legal matter update message 175 using an email application running on the mobile device 110. The legal matter management application 115 can facilitate generation of the email message by launching the email application and providing addressing data.

Network 170 can include any hardware/software/and firmware necessary to convey data encoded within carrier waves. Data can be contained within analog or digital signals and conveyed though data or voice channels. Network 170 can include local components and data pathways necessary for communications to be exchanged among computing device components and between integrated device components and peripheral devices. Network 170 can also include network equipment, such as routers, data lines, hubs, and intermediary servers which together form a data network, such as the Internet. Network 170 can also include circuit-based communication components and mobile communication components, such as telephony switches, modems, cellular communication towers, and the like. Network 170 can include line based and/or wireless communication pathways.

As used herein, presented data stores 120 and 155 can be a physical or virtual storage space configured to store digital information. Data stores 120 and 155 can be physically implemented within any type of hardware including, but not limited to, a magnetic disk, an optical disk, a semiconductor memory, a digitally encoded plastic memory, a holographic memory, or any other recording medium. Data stores 120 and 155 can be a stand-alone storage unit as well as a storage unit formed from a plurality of physical devices. Additionally, information can be stored within data stores 120 and 155 in a variety of manners. For example, information can be stored within a database structure or can be stored within one or more files of a file storage system, where each file may or may not be indexed for information searching purposes. Further, data stores 120 and/or 155 can utilize one or more encryption mechanisms to protect stored information from unauthorized access.

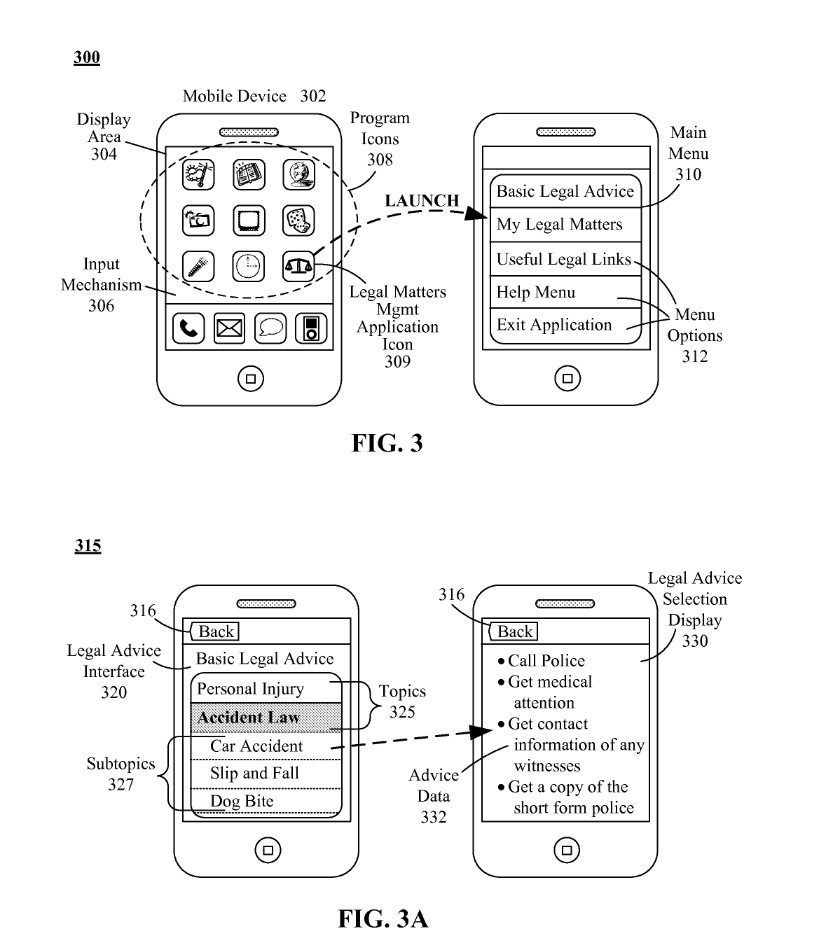

FIG. 2 is a component diagram of a legal matter management application 200 in accordance with embodiments of the inventive arrangements disclosed herein. Legal matter management application 200 can be utilized within the context of system 100 or any other system supporting the automatic provision of legal matter updates to mobile devices.

It should be noted that the components illustrated within the legal matter management application 200 are for illustrative purposes only, and are not meant to be interpreted as an absolute implementation or limitation of an embodiment of the present invention.

The legal matter management application 200 can include one or more graphical user interfaces (GUIs) 205, a legal matter update handler 210, a communications interface 215, and an optional directory service component 220.

A GUI 205 can represent the interaction mechanism by which a user can perform functions with and/or enter data into the legal matter management application 200. Multiple GUIs 205 can exist, each presenting different data and/or functionality. The quantity of GUIs 205 and/or their configuration can depend upon the design and implementation of the legal matter management application 200.

The legal matter update handler 210 can represent the component of the legal matter management application 200 that process received legal matter update messages. For example, the legal matter update handler 210 can parse a legal matter update message to extract or identify keywords that can require interaction with additional programs installed upon the mobile device. Additional functions of the legal matter update handler 210 can include message authentication, sender verification, and message storage.

The communications interface 215 can represent the component of the legal matter management application 200 that can establish use of the various communication media and/or software applications of the mobile device. For example, when a user selects an option from a GUI 205 to call the legal counsel, the communications interface 215 can activate the phone component of the mobile device and provide the phone component with the appropriate phone number to dial.

The directory service component 220 can be an optional component configured to interface with a directory service to provide the user with information about one or more legal counsels. When the directory service is provided by a third-party entity, the function of the directory service component 220 can be incorporated into the communications interface 215. That is, the communications interface 215 can coordinate the data exchange with the directory service.

In one contemplated embodiment, steps can be taken that facilitate a delivery and installation of the legal matter application 115, 200. For example, a characteristic icon can be presented on home pages of law firm Web sites, which indicates that the law firm participates in the legal matter update service. Clicking on the icon can initiate the download and installation process of application 115, 200 to a suitable mobile device 110. In another embodiment, whenever a user provides a mobile phone number to legal counsel 145 as part of an engagement process, a text message can be conveyed to the mobile phone number that provides a link for installing the legal matter management application 115, 200 on the device 110. In another embodiment, device-to-device communications (e.g., BLUETOOTH) can permit two different clients 105 to exchange data, which includes permitting one client 105 to pass the legal matter management application 115, 200 to another. In another embodiment, email messages sent from a business computing system 135 to a client 105 can include a link or option to receive legal matter update messages 175 via an installable legal matter management application 115, 200. In all of the above scenarios, when the application 115, 200 is installed configuration options specific to the legal counsel 145 and type of client 105 matter being handled can be established.

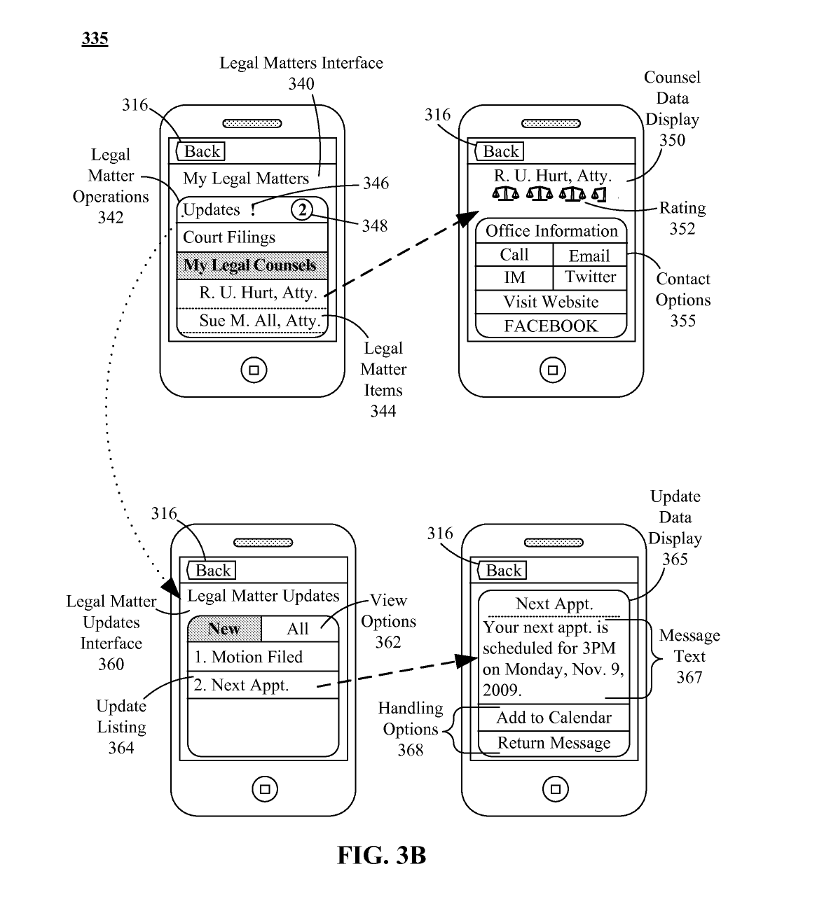

FIG. 3 is a collection 300 of mobile device 302 graphical user interfaces (GUIs) illustrating a sample implementation of the legal matter management application in accordance with embodiments of the inventive arrangements disclosed herein. The GUIs depicted in collection 300 can be utilized within the context of system 100 and/or the legal matter management application 200 of FIG. 2.

It should be appreciated that the GUIs presented in FIGS. 3, 3A, and 3B are for illustrative purposes only, and that additional configurations and functionalities can be incorporated without diverging from this embodiment of the present invention.

In collection 300, a mobile device 302, an iPHONE in this example, can provide access to the legal matter management application via a legal matter management application icon 309. The mobile device 302 can include a display area 304 and an input mechanism 306, which, in this example, are one-in-the-same. That is, the display area 304 of an iPHONE 302 can also be used as the input mechanism 306, a touch screen.

The legal matter management application icon 309 can be presented in addition to other program icons 308, representing other software applications and/or services installed upon the mobile device 302. Selection of the legal matter management application icon 309 using the input mechanism 306 to launch the legal matter management application, resulting in the display of the main menu 310.

The main menu 310 can present the user with high-level menu options 312. As shown in this example, the menu options 312 of the main menu 310 can include a basic legal advice option, a “My Legal Matters” option, an option for useful legal links, a help menu option, and an exit application option.

FIGS. 3A and 3B, each discussed below, can illustrate GUIs specific to the basic legal advice and “My Legal Matters” options 312 of the main menu 310. Selection of the basic legal advice option 312 can present the user with GUIs 320 and 330 such as those shown in FIG. 3A. Selection of the “My Legal Matters” option 312 can present the user with GUIs 340, 350, 360, and 365 such as those shown in FIG. 3B.

Within the display area 304 of the mobile device 302, Selection of the BACK button 316 can return the user to the main menu 310.

FIG. 3B can represent a collection 315 of GUIs 320 and 330 that can be presented to the user after selection of the basic legal advice option 312 from the main menu 310. The legal advice interface 320 can present the user with various legal topics 324. Selection of a topic 325 can present additional subtopics 327, when available.

A BACK button 316 can also be presented to provide return navigation within the legal matter management application. The functionality of the BACK button 316 need not be incorporated into any specific interface, but can be a function of the overall legal matter management application.

As shown in this example, the “Accident Law” topic 325 can be selected, as indicated by the shading, which can present the “Car Accident”, “Slip and Fall”, and “Dog Bite” subtopics 327. Further, selection of the BACK button 316 can return the user to the main menu 310.

The selection of a subtopic 327 or topic 325, in the case when no subtopics 327 exist, can result in presentation of the legal advice selection display 330. The legal advice selection display 330 can present advice data 332 to the user for perusal. From the legal advice selection display 330, the BACK button 316 can return the user to the legal advice interface 320.

As shown in this example, the advice data 332 can be text presented within legal advice selection display 330. The advice data 332 can also include hyperlinks, images, playable audio and/or video, uniform resource locators (URLs), and the like. However, since the legal matter management application is designed to operate on a mobile device 302, resource constraints such as memory space should be considered.

FIG. 3B can represent a collection 335 of GUIs 340, 350, 360, and 365 that can be presented to the user after selection of the “My Legal Matters” option 312 from the main menu 310. The legal matters interface 340 can present the user with various legal matter operations 342. From the legal matters interface 340, the BACK button 316 can return the user to the main menu 310.

The updates legal matter operation 342 can be of particular note within the legal matters interface 340. When a user has received new legal matter update messages from a legal counsel, the legal matters interface 340 can draw attention to the updates legal matter operation 342 with a graphical indicator 346. In this example, the graphical indicator 346 can be an exclamation point (!), and can also utilize visualizations that are unable to be captured within these Figures, such as color changes and animation effects.

Additionally, the updates legal matter operation 342 can include a quantity indicator 348 to denote the quantity of legal matter update messages requiring the user's attention. The value of the quantity indicator 348 can change dynamically as new legal matter update messages are received and the user views the messages.

Selection of the updates legal matter operation 342, as indicated by the dotted line, can result in the presentation of the legal matters updates interface 360. From the legal matters updates interface 360, the BACK button 316 can return the user to the legal matters interface 340.

The legal matters updates interface 360 can present update listings 364 corresponding to the received legal matter update messages. The legal matters updates interface 360 can include view options 362, by which presentation of the update listings 364 can be filtered.

Selection of an update listing 364 can present the update data display 365. From the update data display 365, the BACK button 316 can return the user to the legal matters updates interface 360. The update data display 365 can present the user with the message text 367 as well as one or more handling options 368. The handling options 368 can be specific to the type of legal matter update message.

For example, since the message text 367 shown refers to the scheduling of an appointment, the handling options 368 can include an “Add to Calendar” option. In the case of a message regarding document availability, the “Add to Calendar” handling option 368 can be omitted.

Selection of the “Add to Calendar” handling option 368 can create an appointment for the date and time specified within the message text 367 within a calendar software application installed upon the mobile device 302. Selection of the “Return Message” handling option 368 can provide the user with available electronic communication options supported by the mobile device 302 such as email. Activating a handling option 368 or selecting the BACK button 316 can return the user to the legal matters updates interface 360.

Within the legal matters interface 340, some legal matter operations 342 can include related legal matter items 344. As shown in this example, the “My Counsels” operation 342 can be selected, as indicated by the shading, which can present legal matter items 344 corresponding to the legal counsels from which the user receives legal matter update messages.

Selection of a legal counsel 344, as illustrated by the dashed arrow, from the legal matters interface 340 can result in the presentation of the counsel data display 350. The counsel data display 350 can present information about the selected legal counsel, such as those data items contained within an associated counsel profile. Selection of the BACK button 316 while viewing the counsel data display 350 can return the user to the legal matters interface 340.

The information presented within the counsel data display 350 can be the same as obtained from utilizing the find legal counsel option 312 in the main menu 310. In addition to general information, a rating 352 for the selected legal counsel can also be displayed. The rating 352 can represent a composite score based upon user feedback collected by the directory service. One or more contact options 355 can also be presented within the counsel data display 350. Selection of a contact option 355 can activate the corresponding feature or software application of the mobile device 302.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. An automated system for providing legal matter updates comprising:
a legal matter management application running on a mobile device configured to organize legal matter data pertaining to at least one legal proceeding; and
a legal matter update service application configured to identify and convey legal matter update messages about the at least one legal proceeding from a legal business computing system to the legal matter management application, wherein a legal matter update message comprises at least one element of legal matter data.

2. The system of claim 1, wherein the legal matter management application further comprises:
a user interface configured to present a plurality of interactive GUIs within a display area of the mobile device, wherein at least one interactive GUI provides at least one contact option to a selected legal counsel;
a legal matter update handler configured to process the legal matter update messages for storage as legal matter data and presentation within the user interface; and
a communications interface component configured to access and utilize at least one communication medium supported by the mobile device.

3. The system of claim 2, further comprising:
a directory service component configured to obtain profile data for at least one legal counsel corresponding to at least one user-entered criterion.

4. The system of claim 3, wherein the profile data is provided by a third-party directory service.

5. The system of claim 2, wherein the at least one communication medium comprises at least one of an email, an instant message, a cell phone call, a video player, an audio player, a streaming video transmission, and a social network update.

6. The system of claim 1, wherein the legal matter management application is further configured to facilitate an initial contact between a user of the legal matter management application and a legal counsel, wherein the legal counsel is at least one of a provider of the legal matter management application and a member of a service that provides data to the legal matter management application.

7. The system of claim 1, wherein the legal matter data comprises at least one of data extracted from legal matter update messages and predefined legal advice data.

8. The system of claim 1, further comprising:
a legal matter server having a data store configured to mediate communications between the legal matter update service application and the legal matter management application, wherein, when the legal matter management application is unavailable, the legal matter update messages are stored within the data store for future conveyance.

9. The system of claim 1, wherein the legal matter management application is further configured to exchange data with at least one other software application installed upon the mobile device.

10. An automated method for providing legal matter updates comprising:
detecting of a predefined event within a legal business computing system by a legal matter update service, wherein said predefined event requires an electronic communication to at least one designated legal client;
automatically generating a legal matter update message for the predefined event; and
conveying the legal matter update message to a legal matter management application running on a mobile device of the at least one designated legal client.

11. The method of claim 10, wherein the predefined event comprises at least one of a manual invocation of the legal matter update service, an addition of an electronic document, a modification of an existing electronic document, and a change in a specified data field of a supporting software application.

12. The method of claim 10, wherein the conveying of the legal matter update message further comprises:
determining a network accessibility status of the mobile device, wherein the network accessibility status comprises at least one of an online status and an offline status; and
when the network accessibility status of the mobile device is offline, storing the legal matter update message in a data store for conveyance at a future time.

13. The method of claim 10, further comprising:
upon receipt of the legal matter update message, presenting an update indicator within at least one of a display area of the mobile device and a graphical user interface (GUI) of the legal matter management application; and
displaying the legal matter update message within the GUI of the legal matter management application.

14. The method of claim 13, wherein the update indicator comprises at least one of playing an audio effect, displaying a graphical element, changing a color of a graphical element, and initiating a vibration effect of the mobile device.

15. The method of claim 10, wherein the automatic generation of the legal matter update message further comprises:
aggregating at least one data item pertaining to the detected predefined event from the legal business computing system.

16. A computer program product comprising a computer readable storage medium having computer usable program code embodied therewith, the computer usable program code comprising:
computer usable program code configured to detect a predefined event within a legal business computing system, wherein said predefined event requires an electronic communication to at least one designated legal client;
computer usable program code configured to automatically generate a legal matter update message for the predefined event; and
computer usable program code configured to convey the legal matter update message to a legal matter management application running on a mobile device of the at least one designated legal client.

17. The computer program product of claim 16, wherein the predefined event comprises at least one of a manual invocation of the legal matter update service, an addition of an electronic document, a modification of an existing electronic document, and a change in a specified data field of a supporting software application.

18. The computer program product of claim 16, wherein the conveying of the legal matter update message further comprises:
computer usable program code configured to determine a network accessibility status of the mobile device, wherein the network accessibility status comprises at least one of an online status and an offline status; and
computer usable program code configured to, when the network accessibility status of the mobile device is offline, store the legal matter update message in a data store for conveyance at a future time.

19. The computer program product of claim 16, further comprising:
computer usable program code configured to, upon receipt of the legal matter update message, present an update indicator within at least one of a display area of the mobile device and a graphical user interface (GUI) of the legal matter management application; and
computer usable program code configured to display the legal matter update message within the GUI of the legal matter management application.

20. The computer program product of claim 16, wherein the automatic generation of the legal matter update message further comprises:
aggregating at least one data item pertaining to the detected predefined event from the legal business computing system.
